(19) United States
(12) Patent Application Publication
(10) Pub. No.: US 2012/0082010 A1
(43) Pub. Date: Apr. 5, 2012

(54) SPIRAL-SPRING BALANCE WHEEL REGULATING MEMBER

(75) Inventors: Benoît Boulenguiez, Annemasse (FR); Eric Jolidon, Les Acacias (CH)

(73) Assignee: ROLEX S.A., Geneva (CH)

(21) Appl. No.: 13/248,423

(22) Filed: Sep. 29, 2011

(30) Foreign Application Priority Data
Oct. 4, 2010 (EP) 10405183.4

(51) Int. Cl. G04B 1/22

(52) U.S. Cl. 368/184

(57) ABSTRACT

This spiral-spring and balance wheel regulating member includes a shaft mounted pivotably on the frame of a timepiece. The spiral spring includes at least one blade, whose inner end is designed to be fixed to the pivot shaft and whose outer end is made in one piece with a member (2) for connection to the frame, the rigidity of this connecting member being substantially greater than that of the spiral. The connecting member (2), on one hand, and the frame (9) or a member (6) for the angular positioning of the regulating member on the frame, on the other hand, both have respective bearing surfaces which are at least partially complementary, and fixing means are used to join these complementary bearing surfaces.

The present invention relates to a spiral-spring and balance wheel regulating member including a shaft mounted pivotably on the frame of a timepiece, in which the spiral spring of the regulating member includes at least one blade located in a plane, whose inner end is designed to be fixed to the pivot shaft and whose outer end is made in one piece with a member for connection to the frame, the rigidity of this connecting member being substantially greater than that of the spiral. The invention also relates to a timepiece movement or to a timepiece comprising a regulating member of this kind.

There is a plurality of known methods of fastening the outer end of the spiral spring to the frame of the timepiece. As a general rule, this end is fixed, unlike the inner end which is fastened to a collet pressed onto the balance wheel shaft and which oscillates with the spiral-spring and balance wheel regulating member. In most cases, the outer end of the spiral is connected to a fixing stud or flange which is then fastened to a balance bridge.

One method of fastening the end of the spiral spring to a stud is to place it in a hole provided for this purpose in the stud, and then to secure it with a pin or by bonding. The stud is then inserted into a corresponding housing and fixed in position by pressing or by means of a screw.

The position of the spiral spring with respect to the balance wheel shaft must be adjusted in a precise way, because any eccentricity of the spiral spring or any departure from perpendicularity with respect to this shaft gives rise to serious timekeeping faults, particularly in relation to the isochronism of the regulating member. The stud must therefore be perpendicular to the plane of the spiral spring and must be positioned in a precise way to ensure the concentric development of the spiral spring. In the case of a conventional spiral spring made from an alloy, when the outer end of the spiral spring has been fixed to the balance bridge, directly or by means of an angular adjustment member, any defects created in the ideal three-dimensional shape of the spiral spring are corrected by plastic deformation of the outer end of the spiral spring. This is a highly complex operation which can only be performed by an experienced watchmaker. Moreover, this method of correction is evidently unsuitable for spiral springs made from fragile materials such as silicon, as this kind of material cannot be deformed in a plastic way.

Spiral-spring and balance wheel regulating members in which the outer end of the spiral spring is made in one piece with a frame connection member and which have a substantially greater rigidity than the spiral spring have been described in EP 1 515 200 for example, and also in WO 2006/123095 and EP 2 151 722. However, the proposed methods of fixing the outer end are still related to the conventional stud fixing method, in that they provide only a single attachment point which cannot ensure that the spiral spring, in its rest position, will retain the three-dimensional integrity of its initial shape after it has been fixed.

Thus these solutions cannot overcome the problem of fixing the outer end of a spiral spring in such a way that no correction is needed after fixing. This is because, when these conventional fixing methods are used, it is impossible to ensure that there will be no deformation in the spiral spring, that the spiral spring will maintain a concentric development with respect to the balance wheel pivot axis during the oscillation of the spiral-spring and balance wheel regulating member, or that the spiral spring will remain perpendicular to this axis.

If the spiral spring is made from a fragile material such as silicon, diamond or quartz, adjustment of the spiral spring by plastic deformation becomes impossible, and therefore the use of a stud requires extremely narrow manufacturing tolerances and a robust stud and spring assembly to ensure that the axis of the stud and the plane of the spiral spring are completely perpendicular to each other, or as nearly perpendicular as possible. This clearly gives rise to major difficulties in industrial production. Indeed, the clamping of the stud in its housing, by means of a screw for example, is in itself capable of changing the orientation of the stud and thus modifying the initial three-dimensional shape of the spiral spring.

It has been proposed, in EP 1 918 791 for example, that the stud be provided with means for modifying its angular or radial position, in order to correct defects in the concentric development of the spiral spring without the need for plastic deformation of the spiral spring. However, this solution cannot correct defects in the perpendicularity of the spiral spring with respect to the axis of the balance wheel. This solution also requires a high degree of skill for the very precise adjustment of an element which is located at the end of a spiral spring and which is therefore subject to the action of a large lever arm.

The object of the present invention is to overcome, at least partially, the aforementioned drawbacks.

For this purpose, the invention proposes a spiral- spring and balance wheel regulating member as claimed in claim 1.

Various embodiments of the regulator are defined by claims 2 to 17.

A timepiece movement according the invention is defined by claim 18.

A timepiece according the invention is defined by claim 19.

Advantageously, the profile and angular extension of the complementary bearing surfaces of the connecting member and of the frame or of a member for the angular positioning of the regulating member on the frame have a shape and size such that the three-dimensional integrity of the initial shape of the spiral spring is preserved in the resting state, after the complementary bearing surfaces have been fixed to each other.

The angular extension of the bearing surfaces may be large. It may be as great as 360°, which will provide an extremely stable support. Such complementary bearing surfaces can be produced with a very high degree of precision. For a given manufacturing tolerance, a large bearing surface or a plurality of separate bearing surfaces located along the connecting member with a large angular interval will impart a greater geometrical stability to the assembly. The bearing surface fastened to the outer end of the spiral spring is advantageously made in one piece with the spiral spring, particularly if the spiral spring is cut from a silicon plate, thus enabling a very high degree of precision to be achieved.

Advantageously, the respective bearing surfaces, which are at least partially complementary, of the connecting member and of the frame or of the member for the angular positioning of the regulating member on the frame include at least two elements for positioning the outer end of the spiral spring with respect to the axis of the balance wheel shaft and to the fixing of the inner end of the spiral spring on the balance wheel shaft, in order to position these ends as precisely as is permitted by the tolerances. Ideally, these positioning elements enable the initial shape of the spiral spring to be preserved in the resting position of the regulating member.

The attached drawings show, schematically and by way of example, various embodiments of the regulating member proposed by the invention.

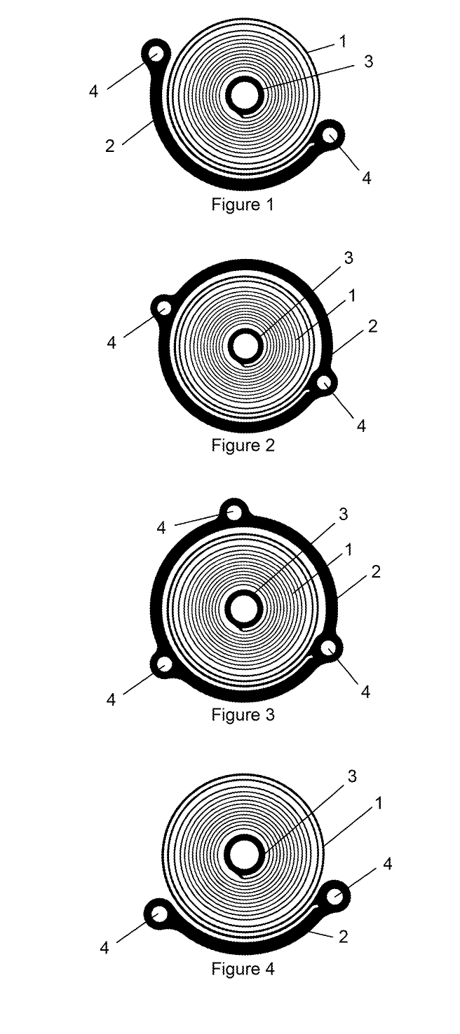

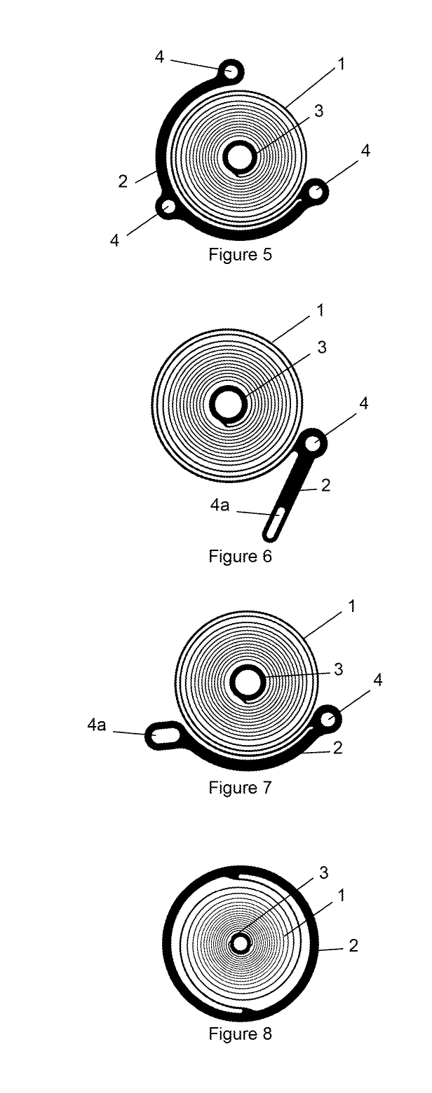

FIGS. 1 to 8 are plan views of some but not all of the various possible shapes of the connecting member and the bearing surface or surfaces fastened to the outer end of the spiral spring forming part of this regulating member;

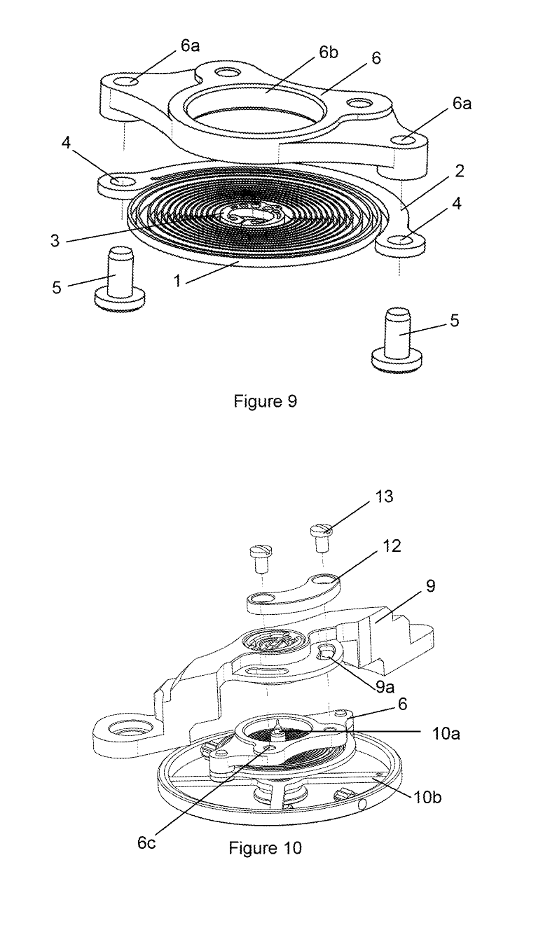

FIG. 9 is an exploded perspective view of a first step of the assembly of a first variant of a first embodiment;

FIG. 10 is an exploded perspective view of a second step of the assembly of the first variant of the first embodiment shown in FIG. 9;

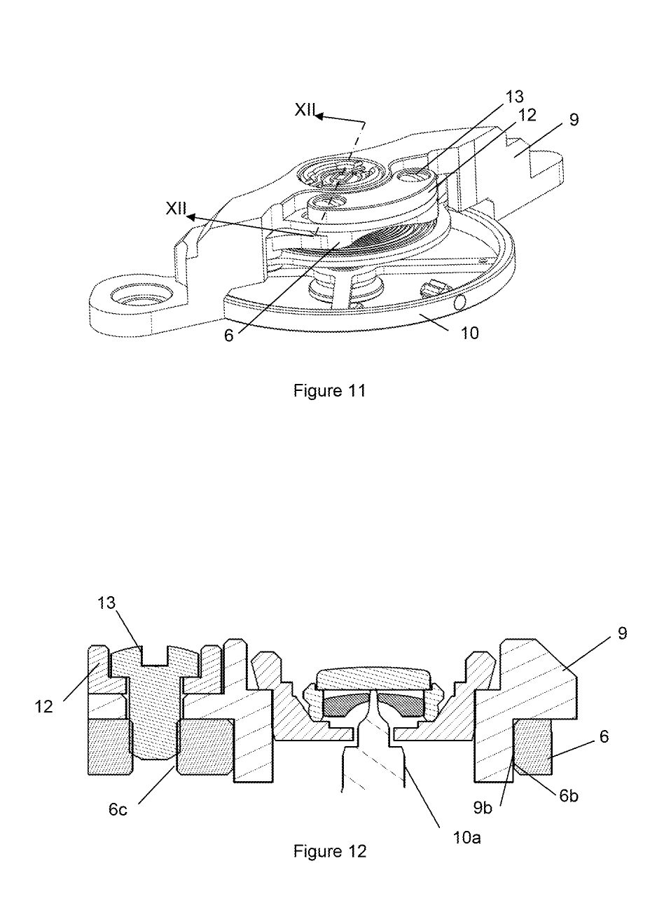

FIG. 11 is an assembled perspective view of FIG. 10;

FIG. 12 is a section taken along the line XII-XII of FIG. 11;

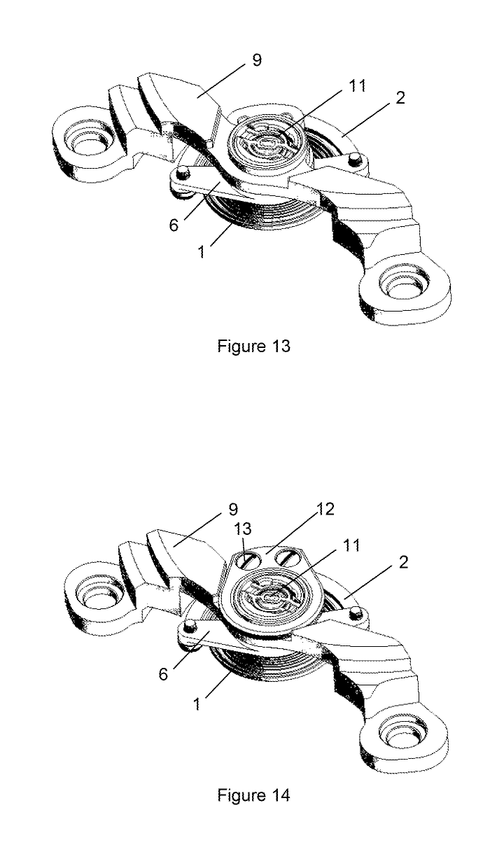

FIG. 13 is a perspective view of a first step of the assembly of a second variant of the first embodiment;

FIG. 14 is a perspective view of a second step of the assembly of the variant shown in FIG. 13;

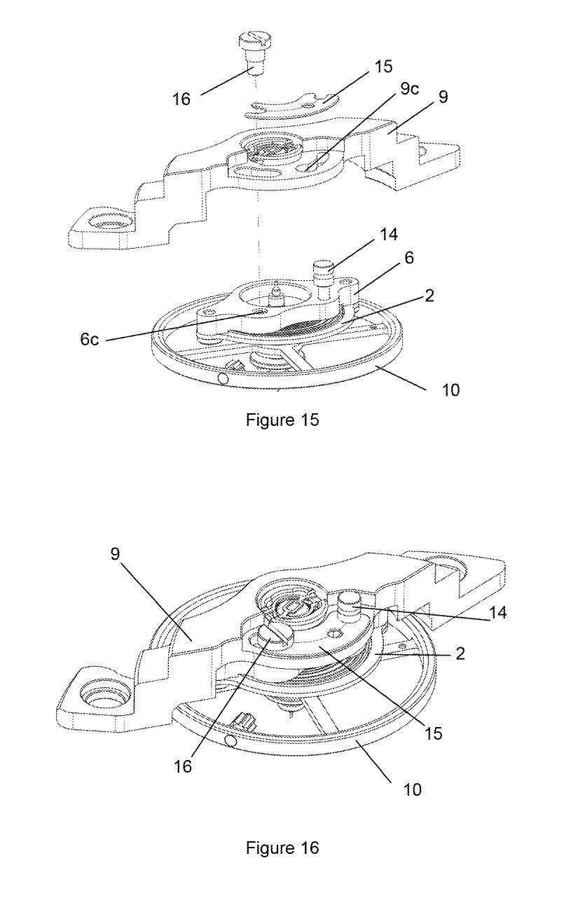

FIG. 15 is an exploded perspective view of a third variant of the first embodiment;

FIG. 16 is an assembled perspective view of FIG. 15;

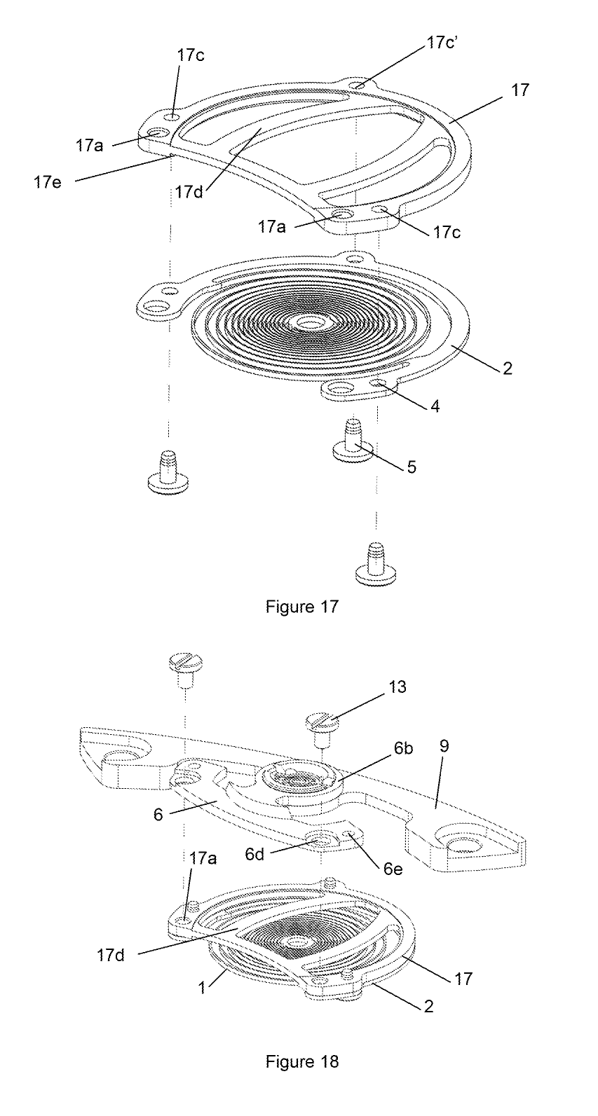

FIG. 17 is an exploded perspective view of a first step of the assembly of a fourth variant of the first embodiment;

FIG. 18 is an exploded perspective view of a second step of the assembly of the variant shown in FIG. 17;

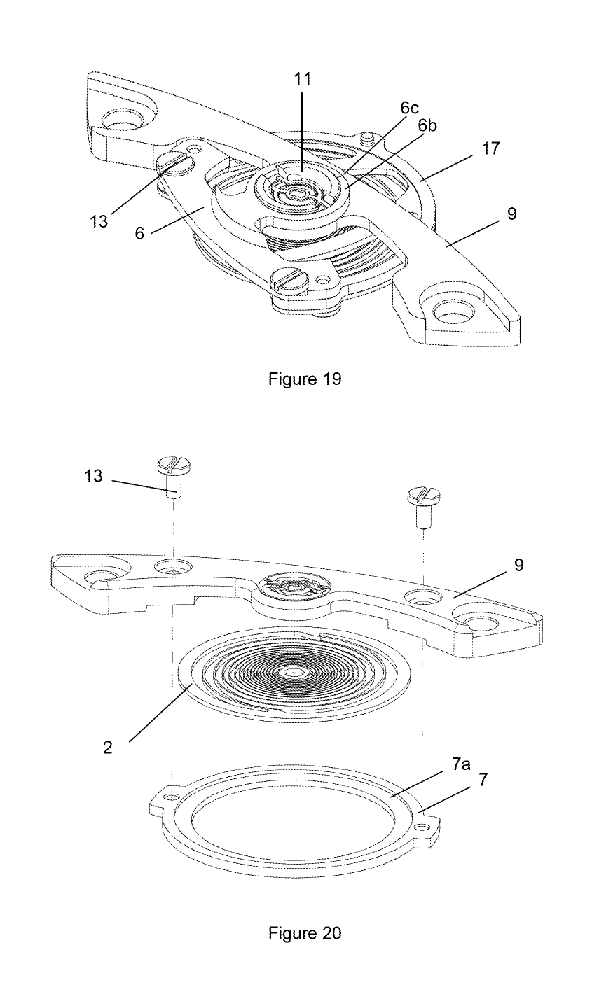

FIG. 19 is an assembled perspective view of FIG. 18;

FIG. 20 is an exploded perspective view of a variant of a second embodiment;

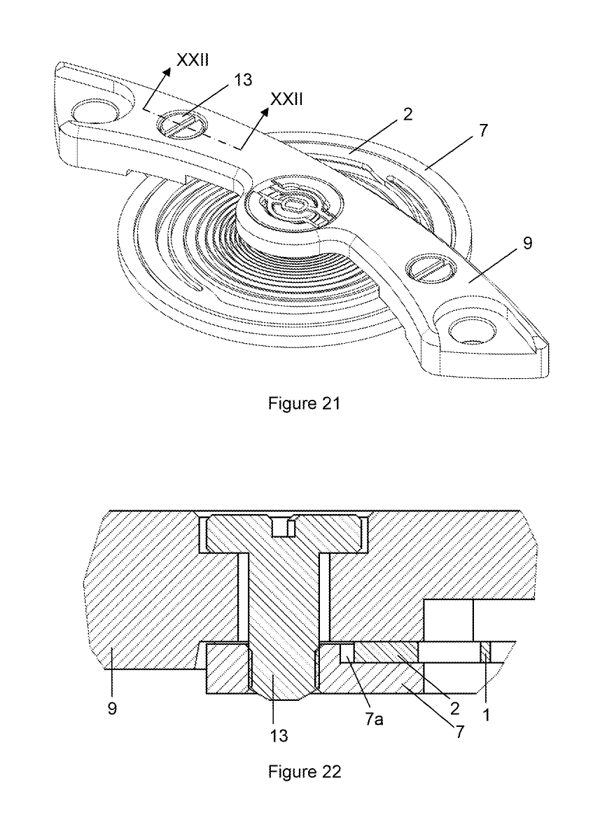

FIG. 21 is an assembled perspective view of FIG. 20;

FIG. 22 is a section taken along the line XXII-XXII of FIG. 21;

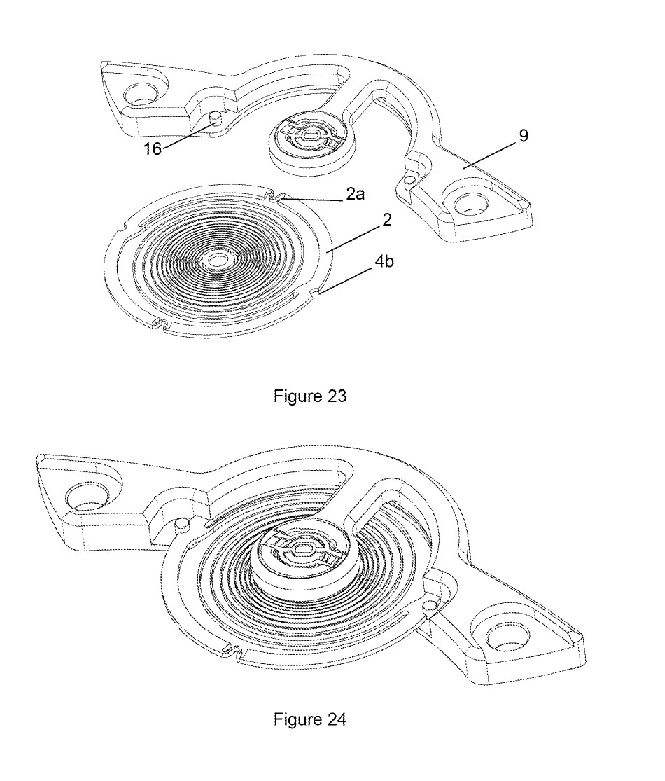

FIG. 23 is a perspective view of a first variant of a third embodiment;

FIG. 24 is a perspective view of FIG. 23 with the spiral spring fastened to the bridge;

FIG. 25 is a perspective view of a fourth embodiment;

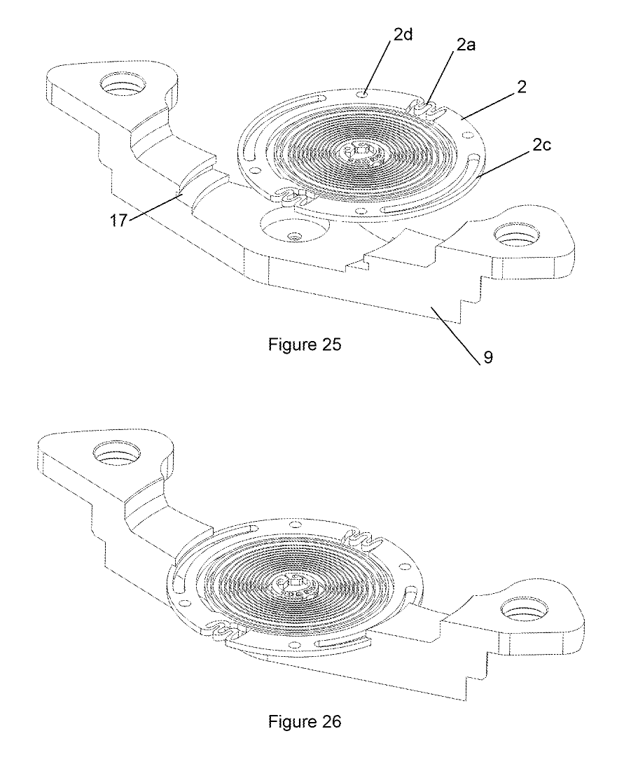

FIG. 26 is a perspective view of FIG. 25 with the spiral spring fastened to the bridge.

FIGS. 1 to 8 show eight variants of spiral springs 1 whose outer ends are made in one piece with a member 2 for connection to the frame of a timepiece. The rigidity of this connecting member 2 is substantially greater than that of the spiral 1, being typically 1000 times greater in the plane of the spiral, and 10 times greater perpendicularly to the plane of the spiral. Preferably, the inner end of each of these spiral springs is also made in one piece with a fixing collet 3, designed to be pressed in the usual way onto the pivot shaft of a balance wheel. As can be seen, the connecting member 2 extends angularly with respect to the pivot axis of the shaft onto which the collet 3 is to be pressed. This connecting member can therefore provide at least one stable bearing surface for the spiral spring 1, if it is associated with a bearing surface which is at least partially complementary, as described below. These bearing surfaces are substantially parallel to the plane of the spiral spring 1.

In the variants of FIGS. 1 to 7, the connecting member 2 advantageously includes two or possibly three positioning and fixing elements, formed by openings 4 for the passage of fixing members such as pins or screws. These openings are preferably distributed angularly to enable the connecting member 2 to be applied against the complementary bearing surface at a plurality of points on its bearing surface. Thus, subject to the accepted tolerances, the spiral spring retains the three-dimensional integrity of its initial shape when in the resting state, once the connecting member has been fixed to its complementary bearing surface.

As shown in FIGS. 6 and 7, some of the openings 4a can be non-circular, being of elongate shape for example, for the correction of any small centering defects due to the accepted tolerances. Thus, the opening of elongate shape 4a can be associated with an eccentric adjustment member whose angular displacement permits fine adjustment of the centering of the spiral with respect to the frame, by the rotation of the connecting member 2 with respect to the center of the opening 4, the connecting member 2 being clamped after the centering of the spiral spring 1. The fineness of the positioning is proportional to the separation between the openings 4 and 4a. The eccentric adjustment member can also be associated with the circular opening 4, but this variant is less favorable for the adjustment, since it requires both openings 4 and 4a to be moved by the action of the adjustment member.

The variant in FIG. 8 relates to an annular connecting member 2, in this case associated with a spiral spring having two blades offset angularly by 180°, wherein the connecting member 2 does not include a positioning and fixing element. This annular connecting member 2 can be fixed, for example, as shown in FIGS. 20 to 22 which are described below.

Clearly, the annular connecting member 2 of FIG. 8 can also be used with a spiral spring having a single blade, such as those shown in FIGS. 1 to 7. On the other hand, the annular connecting members 2 of FIGS. 1-7 can also be used with spiral springs of the type having a plurality of blades.

There are various possible solutions for fixing the connecting member 2 to the frame of the timepiece movement. The connecting member can be fixed directly to the balance bridge, or, advantageously, it can be fixed to the balance bridge by means of an intermediate part, mounted pivotably about the pivot axis of the balance wheel shaft, thus making it possible to set the reference position of the timepiece. The reference position is set by bringing the center of the impulse pin of the balance wheel on to the line linking the corresponding pivot centers of the balance wheel and the lever when the spiral-spring and balance wheel regulating member is in the equilibrium position.

FIGS. 9 to 12 show a first variant of a first embodiment, in which the connecting member 2 includes at least two positioning elements and corresponding bearing surfaces. FIG. 9 shows a spiral spring similar to that illustrated in FIG. 1. Two fixing pins 5 are designed to pass through the openings 4 in the connecting member 2 and to be pressed into corresponding openings 6a formed in an intermediate part 6, provided with an opening 6b which is concentric with the central axis of the collet 3 after the assembly of the elements of FIG. 9. The opening 6b in this intermediate part 6 is designed to be adjusted over a circular range of the balance bridge coaxial with the pivot axis of the balance wheel shaft, to enable the reference position to be set as described below. This intermediate part 6 therefore acts as an angular positioning member of the spiral-spring and balance wheel regulating member.

FIG. 10 shows the step of assembly following that of FIG. 9. The angular positioning member 6 is mounted pivotably about the balance bridge 9, and is fixed to the latter by means of two screws 13, which pass through a clamping plate 12 on the one hand and through two oblong cut-outs 9a in the balance bridge 9 on the other hand, and are screwed into two tapped holes 6c in the angular positioning member 6. In this case, the clamping plate 12 is curved and is mounted on the plate of the balance bridge 9. The pivot shaft of the balance wheel 10a and the balance wheel 10b can be attached to the spiral before or after the mounting of the intermediate part 6.

FIG. 11 shows this first variant in the assembled condition. The reference point of the spiral-spring and balance wheel regulating member 10 can be set by slackening the two screws 13 slightly, then pivoting the fixed assembly formed by the spiral 1 whose inner end is fastened to the shaft 10a of the spiral-spring and balance wheel 10, the angular positioning member 6, and the clamping plate 12.

FIG. 12 shows a section through FIG. 11, to demonstrate the way in which the angular positioning member 6 is mounted pivotably by means of its opening 6b about a cylindrical range 9b of the balance bridge 9.

FIGS. 13 and 14 show a second variant of the first embodiment. The spiral spring 1 which is used corresponds to that shown in FIG. 1. It includes a connecting member 2 extending through approximately 180° about the pivot axis of the balance wheel shaft, whose ends are fixed to the angular positioning member 6 mounted pivotably under the balance bridge 9 about the pivot bearing 11 of one of the ends of the balance wheel shaft. FIG. 13 shows this angular positioning member 6 and FIG. 14 shows the same elements as FIG. 13, but after a plate 12 has been fixed to this angular positioning member 6 by two screws 13. The plate 12 and the angular positioning member 6 are thus mounted by a friction fit about the bearing 11, enabling the reference position to be set in a conventional way as with a standard stud holder.

FIGS. 15 and 16 show a third variant of the first embodiment wherein the angular positioning member 6 carries a shouldered pin 14 for the provisional fixing of the spiral-spring and balance wheel regulating member 10 in a bayonet fixing opening 9c formed in the plate of the balance bridge 9 as shown in FIG. 15. A foil 15 is then placed with one of its ends between the plate of the balance bridge 9 and the shoulder of the pin 14, while its other end is located between the plate of the bridge 9 and the head of a single shouldered screw 16 which is screwed so as to bear on the angular positioning member 6, thus generating sufficient frictional torque to hold the connecting member 2 while allowing the easy setting of the reference position of the spiral-spring and balance wheel regulating member 10.

FIGS. 17 to 19 show a fourth variant of the first embodiment, which is particularly suitable for the mounting of a double spiral in which the outer ends of the blades are fastened to a connecting member 2 in the shape of a ring, in this particular case an open ring.

FIG. 17 shows a first step of assembly. In this case, the spiral 1 is fastened to the spiral support 17 by three pins 5 which pass through the openings 4 of the spiral 1 and are pressed into the openings 17c of the intermediate part 17.

The fixing points can be simple circular positioning holes 4 formed in the ring-shaped connecting member 2. In a variant, the positioning holes 4 of the connecting member 2 could incorporate flexible arms (not shown) for correct positioning, or could have an open profile in the form of a split tube having a degree of resilience, thus forming resilient arms to provide clamping around the pins 5.

FIG. 18 shows a second step of assembly. The spiral support 17 fitted with the spiral spring 1 is connected to the balance bridge 9 by the angular positioning member 6, by means of two screws 13 which pass through openings 6d in the member 6 and are screwed into the tapped holes 17a of the support 17. The whole assembly is correctly positioned by means of the extended length of the pins 5 which are housed in adjusted openings 6e in the member 6.

FIG. 19 shows the complete assembly. In this case it can be seen that the angular positioning member 6 is provided with a ring 6b having a slit 6c for the angular positioning of the regulating member by friction around the bearing 11 of the balance wheel shaft, which is fixed to the balance bridge 9, thus permitting simple setting of the reference position.

The manufacturing tolerances of the spiral support 17 are greater than those of the spiral spring 1, and consequently the clearance at each fixing 17c can be adjusted to provide the most precise retention possible without overloading the system and making it statically indeterminate. A possible way of ensuring correct assembly is to leave a greater clearance at the intermediate fixing point 17c′, which then has a greater diameter than the others, in order to absorb the various errors due to the manufacturing tolerances on the other components. An alternative method is to specify the clearances of all the attachment points as a function of the tolerances of the rigid part.

The lower face of the spiral support 17 has a cut-out 17e to avoid friction with the spiral spring. The arms 17d of the support 17 act as a stop to prevent deformations of the spiral 1 under the effect of an impact.

A second embodiment is shown in FIGS. 20 to 22. This solution uses the spiral spring of FIG. 8, but can also be used with any other spiral spring having a similar connecting member 2. In this solution, the more rigid annular connecting member 2 is clamped axially between an intermediate fixing part 7, having a positioning recess 7a (FIG. 22) to receive the annular connecting member 2, and the balance bridge or an angular positioning member. This positioning recess 7a allows the reference position of the spiral-spring and balance wheel regulating member to be set when the inner end of the spiral is assembled onto the balance wheel shaft. Two fixing screws 13 are used to clamp the annular connecting member 2 between the balance bridge 9 and the intermediate fixing part 7, the depth of the recess 7a formed in the intermediate fixing part 7 being a few hundredths of a millimeter smaller than the thickness of the annular connecting member 2 (FIG. 22).

In this case there are not at least two separate fixing or stud points, but a fixing on a bearing surface extending over an arc of a circle of at least 60°. This solution provides simple reference position setting and facilitates the inspection and assembly operations. This is because there is no element covering the spiral spring, and all the turns of the spring remain visible.

In a third embodiment, resilient arms 2a separate two parts of the annular connecting member 2, thus enabling the annular connecting member 2 to be clipped, in the variant shown in FIGS. 23 and 24, around pins 16 pressed into the balance bridge 9, centering being provided by two positioning elements 4b (centering cut-outs) formed in the connecting member 2. The bearing surface extends over an arc of a circle of at least 60°.

In a fourth embodiment, similar to the preceding one, resilient arms 2c are formed, in addition to or in place of the resilient arms 2e, in the edge of the annular connecting member 2 (FIGS. 25 and 26) to enable the ring to be clipped into housings 17 formed for this purpose in the balance bridge 9. The reference position can be set by modifying the angular position of the spiral, for example by means of tools which are inserted into passages 2d formed in the connecting member 2.

These different features, notably the different features of the different embodiments, and/or these different embodiments can be combined with each other provided that they are not incompatible.

1. A spiral-spring and balance regulating member (10) including a shaft designed to be mounted pivotably on a frame (9) of a timepiece, in which the spiral spring (1) of the regulating member (10) includes at least one blade located in a plane, whose inner end is designed to be fixed to the pivot shaft and whose outer end is made in one piece with a member (2) for connection to the frame (9) or to a member (6) for the angular positioning of the regulating member (10) on the frame, the rigidity of this connecting member being substantially greater than that of the spiral, wherein the connecting member (2) on one hand, and the frame (9) or the member (6) for the angular positioning of the regulating member (10) on the frame, on the other hand, both have respective bearing surfaces which are at least partially complementary and substantially parallel to the plane of the spiral, fixing means being used to join these complementary bearing surfaces.

2. The regulating member as claimed in claim 1, wherein the bearing surfaces extend over an angular portion of more than 60°.

3. The regulating member as claimed in claim 1, wherein the bearing surfaces are continuous.

4. The regulating member as claimed in claim 1, wherein a single surface extends for more than 60° about the pivot axis of the shaft, or for more than 120° about the pivot axis of the shaft, or for 180° or more about the pivot axis of the shaft.

5. The regulating member as claimed in claim 1, wherein at least one of the bearing surfaces is discontinuous.

6. The regulating member as claimed in claim 5, wherein two elements of a surface are positioned at more than 60° to each other about the pivot axis of the shaft, or at more than 120° to each other about the pivot axis of the shaft, or at 180° to each other about the pivot axis of the shaft, and/or wherein each of the two elements extends over more than 10°, or more than 20°, about the pivot axis of the shaft.

7. The regulating member as claimed in claim 1, wherein the profile and angular extension of the at least partially complementary respective bearing surfaces have shapes and sizes with respect to the pivot axis of the shaft such that the three-dimensional integrity of the initial shape of the spiral (1) is preserved in the resting state after the complementary bearing surfaces have been fixed to each other.

8. The regulating member as claimed in claim 1, wherein the connecting member (2) includes at least two positioning elements (4) distributed angularly about the pivot axis.

9. The regulating member as claimed in claim 8, wherein the angular interval between the positioning elements is in the range from 60° to 180°.

10. The regulating member as claimed in claim 1, wherein the angular positioning member (6) is mounted pivotably about the bearing (11) for the pivoting of the balance wheel shaft on the balance bridge (9).

11. The regulating member as claimed in claim 1, wherein the connecting member (2) is an annular member.

12. The regulating member as claimed in the claim 11, wherein the annular connecting member (2) is positioned between an intermediate fixing part (7), which has a positioning recess (7a) for receiving the annular connecting member (2), and the lower face of the balance bridge (9), clamping means (8) being designed to clamp the annular connecting member (2) between the intermediate part (7) and the balance bridge (9).

13. The regulating member as claimed in claim 1, wherein the angular positioning member (6) has a shouldered pin (14) to engage with a bayonet fixing opening (9a) in the balance bridge (9), a foil (15) being positioned between the plate of the balance bridge (9) and, on the one hand, the shoulder of the pin (14), and on the other hand a shouldered screw (16) screwed so as to bear against the connecting member (2), this foil creating a frictional torque to retain the connecting member (2) while allowing the reference position of the regulating member to be set.

14. The regulating member as claimed in claim 1, wherein the spiral (1) includes two blades whose respective outer ends are fastened to the connecting member (2), the means for fixing the spiral to the angular positioning member (6) including a more rigid spiral support element (17), fixed to the connecting member with the aid of screws 18.

15. The regulating member as claimed in claim 1, wherein the angular positioning member (6) includes a split ring (6b) for its frictional connection around the bearing (11) of the balance wheel shaft, fastened to the balance bridge (9).

16. The regulating member as claimed in claim 1, wherein the annular connecting member (2) includes resilient parts (2a, 2c) shaped so as to interact with clipping means (17) of the frame (9).

17. The regulating member as claimed in claim 16, including positioning elements (4b) complementary to positioning means (16) of the frame (9), the whole arrangement being such that the clipping means keep the positioning elements and means engaged with each other.

18. A timepiece movement comprising a regulating member as claimed in claim 1.

19. A timepiece comprising a regulating member as claimed in claim 1.
